(19) United States
(12) Patent Application Publication
(10) Pub. No.: US 2016/0198319 A1
(43) Pub. Date: Jul. 7, 2016

(54) METHOD AND SYSTEM FOR COMMUNICATIVELY COUPLING A WEARABLE COMPUTER WITH ONE OR MORE NON-WEARABLE COMPUTERS

(71) Applicant: mophie, inc., Tustin, CA (US)

(72) Inventors: Daniel Huang, Irvine, CA (US); Matthew David Bottomly, Santa Ana, CA (US)

(21) Appl. No.: 14/989,490

(22) Filed: Jan. 6, 2016

Related U.S. Application Data
(63) Continuation of application No. PCT/US2014/045549, filed on Jul. 7, 2014.
(60) Provisional application No. 61/845,316, filed on Jul. 11, 2013.

(51) Int. Cl. H04W 4/14; G06F 3/0488; G06F 3/0484; G06F 3/0482

(52) U.S. Cl. CPC H04W 4/14; G06F 3/0482; G06F 3/0488; G06F 3/04847

(57) ABSTRACT

A wearable computer and method of functionally coupling the wearable computer to a non-wearable computer, the wearable computer including: a control module; a display screen, coupled to the control module, and configured to display text and images; and a wireless communication module, coupled to the control module, and configured to communicate with a non-wearable computing device, wherein the control module is configured to control the display screen to display a notification message in response to a signal received by the wireless communication module from the non-wearable computing device, wherein the signal indicates a status condition of the non-wearable computer and the notification message informs a user of the wearable computer of the status condition.

### CROSS-REFERENCE TO RELATED APPLICATIONS

This application is a continuation of PCT Patent Application No. PCT/US2014/045549, having an international filing date of Jul. 7, 2014, and titled METHOD AND SYSTEM FOR COMMUNICATIVELY COUPLING A WEARABLE COMPUTER WITH ONE OR MORE NON-WEARABLE COMPUTERS, which designates the United States, and which claims the benefit of U.S. Provisional Patent Application No. 61/845,316, filed Jul. 11, 2013, and titled METHOD AND SYSTEM FOR COMMUNICATIVELY COUPLING A WEARABLE COMPUTER WITH ONE OR MORE NON-WEARABLE COMPUTERS. Each of the above-identified patent applications is hereby incorporated by reference in its entirety and is made a part of this specification for all that it discloses.

### BACKGROUND

1. Field of the Disclosure

The present invention relates generally to personal computing and more particularly to a wearable personal computing device capable of communicating with one or more external computing devices.

2. Background of the Disclosure

As used herein “wearable computers” or “wearable computing devices” generally refer to computer devices capable of being worn by a person, such as computing devices in the form of a belt, necklace, wrist watch or glasses, for example. “Non-wearable computers” or “non-wearable computing devices” generally refer to computer devices that are not configured to be worn by a person in a manner that people wear articles of clothing or accessories such as belts, necklaces, wrist watches, bracelets, arm bands, ear-pieces, glasses, surgical implants, clothing patches, electronic undergarments, or worn inconspicuously under clothing, etc. Wearable computers can also include modular flexible processing units capable of interfacing with multiple different expansion sensor/display packages. A central computer unit (containing a processor, a memory, and potentially either wireless communications or internal power) can be placed in a wrist-worn housing with a wrist-related sensor package, and later moved to a separate ear-piece with a head-based sensor package. Based on which sensors the chip or puck is associated with, the central computer unit behaves or monitors differently, for example recognizing that running is detected differently from the perspective of a wrist or from an ear.

Due to the relatively small size, restricted interface and display areas, and limited space available on wearable computers, it is presently difficult to provide the full range of functions provided by larger computing devices, (e.g., smart phones, tablets, laptop computers, etc.), without making the wearable computer overly large or too cumbersome for a user to wear and/or too costly to manufacture.

Because consumers desire the power and large variety of applications available today on non-wearable computers (e.g., smart phones, tablets, etc.), consumers are not willing to replace non-wearable computers with less powerful wearable computing devices. However, because non-wearable computers are not always immediately accessible or “on the person” of the user, users may often miss urgent phone calls, text messages or e-mails, for example. For example, if a user leaves her smart phone in her car and walks away from the car, it is possible the user will not receive an important phone call, and not even realize she missed the phone call until a much later time. Additionally, even if the user can hear her phone ringing, the phone may not be immediately accessible, e.g., in a purse or bag that is not immediately accessible. In such situations, the user cannot conveniently answer or forward the phone call, or stop the phone from ringing if the ringing is causing a disruption, for example.

Additionally non-wearable computers often lack the sensor packages to adequately detect heart rate, body temperature, perspiration, or other body or outside environmental conditions.

In order to address the above-described exemplary problems, and other similar problems, what is needed is a wearable computer that can work together with non-wearable computers to provide notifications concerning events to the user, to monitor the user and the user's environment, and to supplement or complement the functionality of such non-wearable computers, thereby providing enhanced functionality and convenience to the user.

### SUMMARY

The invention addresses the above-described and other needs by providing a wearable computer that is configured to be communicatively coupled to one or more non-wearable computers to supplement and complement the functionality of one or more non-wearable computing devices. By working in conjunction with traditional computing devices, e.g., a smart phone, the wearable computer can provide enhanced functionality and convenience to the user.

In one embodiment, the wearable computer is configured to provide predetermined notifications to a user. In this embodiment, the wearable computer first alerts the user of a pending notification by providing an alert in the form of a vibration alert, and/or audible alert (e.g., a beeping sound) and/or a visual alert (e.g., a flashing light or display screen message or image), which alerts the user that a notification is being provided to the user. The notifications are thereafter or concurrently provided on a display screen of the wearable computer to inform the user of various conditions related to a non-wearable computing device that is communicatively coupled to the wearable computer. Exemplary notifications can include a message displayed on the display screen informing the user that a telephone call is being received, or was missed, by the associated non-wearable computing device (e.g., a smart phone). Additional or alternative notifications can include a message displayed on the display screen that a text or e-mail message has been received by the associated non-wearable computing device.

In one embodiment, the wearable computer is configured to communicate with one or more non-wearable computers via a short-range wireless communication protocol (e.g., Bluetooth, Bluetooth Low Energy (LE), RFID, UWB, Induction Wireless, or Wifi). In such embodiments, any known or suitable short-range wireless technology may be used to communicatively couple a wearable computer with a non-wearable computer (e.g., smart phone, tablet, laptop computer, personal computer (PC), etc.) Multiple wearable computers can likewise be communicatively coupled to each other to enable expanded sensor or feedback capabilities.

In a further embodiment, in addition to providing a predetermined general notification (e.g., “you received a text message”), the wearable computer can provide further details of an event. For example, a display on wearable computer can display information such as the name of the sender of a text or e-mail message, and also display the message, or a summary or condensed version of the message.

In a further embodiment, in addition to the wearable computer displaying a text message or email message to the user, the wearable computer could also prompt the user with a number of set responses. In this way, a user could text simple questions to the wearable computer user's mobile device, which is transmitted to and displayed on the wearable computer, and the wearable computer user could select simple responses such as “Yes.”, “No.”, or “Later.” from a list of options. The list can be either pre-set by the system or user, or the list of responses could be dynamically populated by a predictive algorithm Using text-to-speech and speech-to-text functions, an audible phonecall could even be transmitted as text messages to and from the wearable computer. As a remote caller speaks questions, the mobile device or wearable computer translates that speech to text and displays the messages to the wearable computer user. The wearable computer user responds via pre-set or intelligently predicted text responses, which are then converted and audibly played for the remote caller.

In a further embodiment, the wearable computer can adjust functionality based on body status, location, and/or a detected activity of a user. For example, using a biosensor, the wearable computer can detect if the user is in a sleep state and suppress alerts when it is determined that the user is sleeping. Some examples of potential biosensors include thermometers, pulse monitors, moisture detectors, motion detectors, and microphones. As another example, the wearable computer may detect that the user is exercising and alter notifications while the user is moving quickly (e.g., increased volume or detected movement from an accelerometer, magnetometer, or location detector such as satellite positioning (e.g., GPS, GLONASS, Beidou, or Galileo) or ground-based positioning (e.g., cellular triangulation, wifi router pairing, Jigsaw, or Cricket v2), or dead reckoning) to activate a heart rate monitor, calorie counter program, or any other application stored within a memory of the wearable computer or alternatively to open an application on a remote system such as a smart phone, an MP3 player, a tablet computer, or even a remote system such as an online application. As a further example, by using location detection (either detected by a location detector in the wearable computer or by gathering data from a paired non-wearable computer with a location detector), the wearable computer can determine a location of the user and activate appropriate protocols based on the user's location or velocity. For example, the wearable computer may detect the user is in a movie theater and display a message such as “It looks like you are at AMC Theater; would you like to mute your phone and disable your WC screen?” Another example would be to determine that a user is driving through a combination of speed detection and recognized accelerometer behavior for a user operating a steering wheel, and therefore disable text messages and any phonecalls other than speakerphone or bluetooth. These profiles can be pre-set to react without any specific user action, although the wearable computer could prompt the user for confirmation. Additionally, priority messages can over-ride current status settings (e.g., an incoming call from a teenage child is processed despite a sleep status).

In another embodiment, the wearable computer includes a display and a touch screen or panel disposed on top of the display screen or a control panel adjacent a display. The wearable computer is programmed to recognize gestures on the touch screen (e.g., a predetermined movement, swipe, etc.) or control panel. When a user performs a predetermined gesture on the touch screen, corresponding instructions or commands are transmitted to a communicatively coupled non-wearable computer. For example, if the wearable computer is in a “smart phone control” mode, a swipe up on the screen could open a current e-mail on the display of the smart phone, without any further actions being performed on the smart phone. As another example, if the wearable computer is in a “TV control” or “game console control” mode, a swipe up or down can indicate a channel or volume change, or other desired instruction, to a smart tv or gaming console.

In a further embodiment, a peripheral stylus or pen could be used that is detected by multiple sensors in the WC, which can record movements. The stylus could record pen tip location to simultaneously create electric records of notes. Stylus could be flipped or a switch could be toggled to function as an indicator or wand to control electronics. In an alternative embodiment, the position of the stylus tip can be monitored by both the wearable computer and the paired non-wearable computer. If a third device such as a gaming console is associated, the stylus location and orientation can also be more accurately determined in three-dimensional space.

In a further embodiment, a single command input on one device, whether that is a wearable computer or an associated device (e.g., a smartphone, tablet, or personal computer) can be transmitted to all paired or connected devices. In one example, selecting a mute option on a wearable computer could set all other paired or connected devices into a mute mode. This concept can extend beyond muting a telephone from your wrist, to include things such as muting a television and stereo system. This mute command could be sent manually by selecting a button or on-screen representation button or automatically by detecting that a user has fallen asleep from device sensors. Another example of an automatic command would include sending a global mute command to all devices (e.g., computer, television, car stereo, smartphone, tablet, personal computer, or wearable computer) when a telephone call or video conference begins. Instead of individually muting or individually enabling audio on each device, a single command can change the status for the entire user system.

Various embodiments can relate to a wearable computer that includes a control module and an output element that is coupled to the control module and configured to convey a status alert to a user of the wearable computer. The wearable computer can include a wireless communication module, coupled to the control module, and configured to communicate with a separate computing device. The control module can be configured to control the output element to convey a status alert to a user in response to a signal received by the wireless communication module from the separate computing device. The signal can indicate a status condition of the separate computer and the status alert can inform a user of the wearable computer of the status condition.

The separate computing device can be a non-wearable computer. The separate computing device can be a second wearable computer.

The output element can include a display screen and conveying a status alert can include displaying a text and/or an image in response to the received signal. The output element can include a vibration module and conveying a status alert can include vibrating in response to the received signal. The output element can include a speaker that is coupled to the control module, and conveying a status alert can include providing an audible alert in response to the received signal.

The status condition can include a condition wherein the separate computing device is receiving an incoming phone call and the status alert notifies the user of the incoming phone call. The output element can include a display screen, and wherein the control module can be further configured to control the display screen to display at least one action that may be selected by the user in response to the incoming phone call. The at least one action can include at least one action selected from a group consisting of: answer the incoming call; ignore the incoming call; send the incoming call to voice mail; send a text message to a device associated with the incoming call; and send an e-mail to the device associated with the incoming call. The wearable computer can include a speaker and a microphone, and if the at least one action selected by the user is to answer the incoming call, the control module can be further configured to control the communication module to communicate with the separate computing device to allow the user to engage in a phone conversation using the speaker and microphone of the wearable computer.

The status condition includes a condition wherein the separate computing device has received a text message and the status alert notifies the user of the received text message. The output element can include a display screen, and the control module can be further configured to control the display screen to display at least one action that may be selected by the user in response to the received text message. The at least one action can include at least one action selected from a group consisting of: read the received text message; send a reply text message to a device associated with the received text message; initiate a telephone call to the device associated with the received text message; and send an e-mail to the device associated with the received text message. The control module can be further configured to send a control signal to the separate computing device so that the separate computing device initiates the at least one action selected by the user.

The status condition can include a condition wherein the separate computing device has received an e-mail message, and the status alert can notify the user of the received e-mail message. The output element can include a display screen, and the control module can be further configured to control the display screen to display at least one action that may be selected by the user in response to the received e-mail message. The at least one action can include at least one action selected from a group consisting of: read the received e-mail message; send a reply e-mail message to a device associated with the received e-mail message; initiate a telephone call to the device associated with the received e-mail message; and send a text message to the device associated with the received e-mail message. The control module can be further configured to send a control signal to the separate computing device so that the separate computing device initiates the at least one action selected by the user.

The wearable computer can include a touch panel formed on top of a display screen, thereby providing a touch screen display. The touch screen display can be configured to receive at least one predetermined touch input from the user to initiate a selected action in response to the received signal.

The wearable computer can include at least one input button that when pressed by the user initiates a selected action in response to the received signal.

Various embodiments relate to a method of functionally coupling a wearable computer to a separate computing device. The method can include communicatively coupling the wearable computer to the separate computing device, and displaying a status alert on a display screen in response to a signal received by a wireless communication module from the separate computing device. The signal can indicate a status condition of the separate computing device, and the notification message can inform a user of the wearable computer of the status condition.

The method can include vibrating the wearable computer in response to the received signal. The method can include generating an audible alert in response to the received signal.

The status condition can include a condition wherein the separate computing device is receiving an incoming phone call, and the notification message can notify the user of the incoming phone call. The method can include displaying on a display screen of the wearable computer at least one action that may be selected by the user in response to the incoming phone call. If the at least one action selected by the user is to answer the incoming call, the method can include establishing two-way communications with the separate computing device to allow the user to engage in a phone conversation using a speaker and a microphone provided with the wearable computer.

The status condition can include a condition wherein the separate computing device has received a text message and the notification message notifies the user of the received text message. The method can include displaying on a display screen of the wearable computer at least one action that may be selected by the user in response to the received text message. The method can include sending a control signal to the non-wearable computer so that the separate computing device initiates at least one action selected by the user.

The status condition can include a condition wherein the separate computing device has received an e-mail message, and the notification message can notify the user of the received e-mail message. The method can include displaying at least one action that may be selected by the user in response to the received e-mail message. The method can include sending a control signal to the separate computing device so that the separate computing device initiates at least one action selected by the user.

Further features and advantages of the present disclosure, as well as the structure and operation of various exemplary embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is block diagram of a wearable computer in accordance with one embodiment of the invention.

FIG. 2 illustrates a wearable computer in the form of a wrist watch, in accordance with one embodiment of the invention.

FIG. 3 illustrates a wearable computer in the form of a necklace, in accordance with one embodiment of the invention.

FIGS. 4A and 4B illustrate exemplary displays and corresponding functions provided by the wearable computer of FIG. 2 when communicatively coupled to a wireless phone (e.g., a smart phone), in accordance with one embodiment of the invention.

FIGS. 5A and 5B illustrate exemplary displays and corresponding functions provided by the wearable computer of FIG. 2 when communicatively coupled to a wireless phone (e.g., a smart phone), in accordance with a further embodiment of the invention.

FIGS. 6A and 6B illustrate exemplary displays and corresponding functions provided by the wearable computer of FIG. 2 when communicatively coupled to a non-wearable computer having e-mail functionality, in accordance with a further embodiment of the invention.

FIGS. 7A and 7B illustrate exemplary displays and corresponding functions provided by the wearable computer of FIG. 2 when communicatively coupled to a non-wearable computer having text messaging functionality, in accordance with a further embodiment of the invention.

FIGS. 8A and 8B illustrate exemplary displays and corresponding functions provided by the wearable computer of FIG. 2 when it is detected that the user is in state of sleep, in accordance with a further embodiment of the invention.

FIGS. 9A and 9B illustrate exemplary displays and corresponding functions provided by the wearable computer of FIG. 2 when it is detected that the user is in state of exercise, in accordance with a further embodiment of the invention.

FIGS. 10A and 10B illustrate exemplary displays and corresponding functions provided by the wearable computer of FIG. 2 when it is detected that the user is in a certain predetermined location (e.g., a local movie theater), in accordance with a further embodiment of the invention.

FIGS. 11A-11B illustrate exemplary displays and corresponding functions provided by the wearable computer of FIG. 2 when it is configured to control one or more non-wearable computers, in accordance with a further embodiment of the invention.

FIGS. 12A-12B illustrate exemplary displays and corresponding functions provided by the wearable computer of FIG. 2 when it is configured to control a smart phone, in accordance with a further embodiment of the invention.

FIG. 13 illustrates an exemplary display and corresponding functions provided by the wearable computer of FIG. 2 when it is configured to control a television, in accordance with one embodiment of the invention.

FIG. 14 illustrates an exemplary display and corresponding functions provided by the wearable computer of FIG. 2 when it is configured to function as an electronic notepad, in accordance with one embodiment of the invention.

FIG. 15 illustrates an exemplary display and corresponding function wherein the wearable computer of FIG. 2 can be used to locate a coupled smart phone, in accordance with one embodiment of the invention.

FIG. 16 illustrates an exemplary display and corresponding function wherein a smart phone can be used to locate a coupled wearable computer, in accordance with a further embodiment of the invention.

FIG. 17 illustrates a further embodiment of the invention wherein a wearable computer can track and record writing from a peripheral stylus or pen.

FIG. 18 illustrates multiple mobile devices working in unison using various sensors located within each device, in accordance with one embodiment of the invention.

### DETAILED DESCRIPTION OF CERTAIN EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

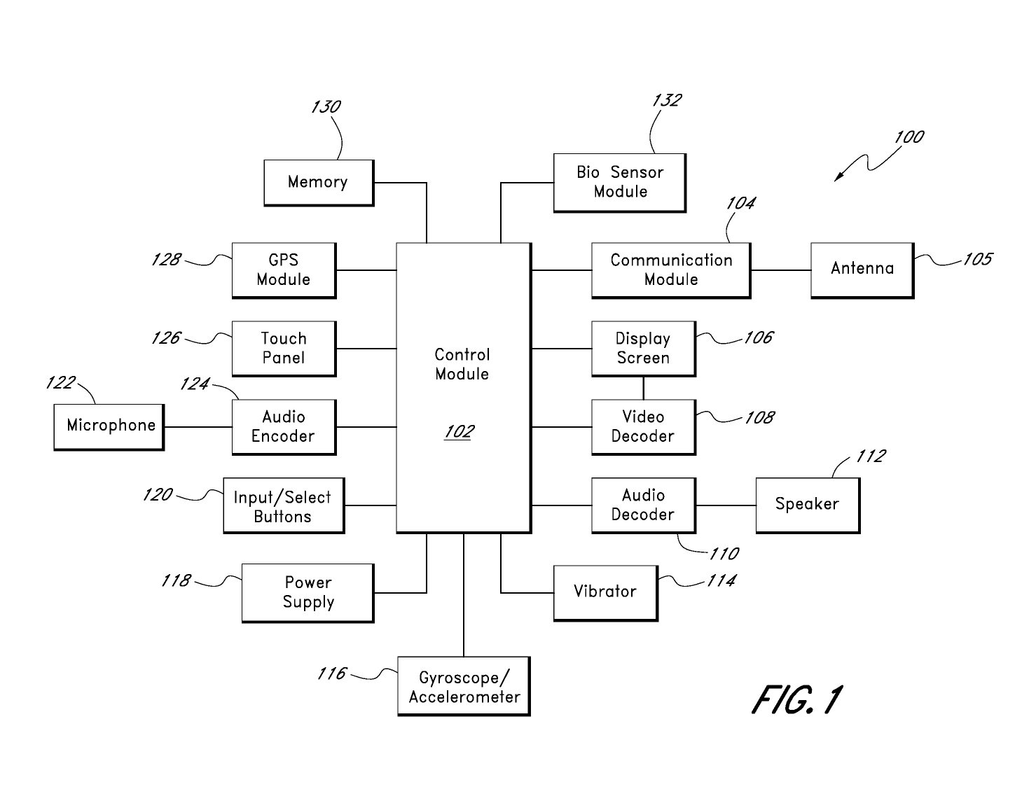

FIG. 1 illustrates a system block diagram of an exemplary wearable computer system 100, in accordance with one embodiment of the invention. The wearable computer system 100 includes a control module 102, a communication module 104, a display screen 106, a video encoder module 108, an audio decoder 110, a speaker 112, a vibrator 114, a gyroscope/accelerometer module 116, a power supply module 118, input/select buttons 120, a microphone 122, an audio encoder 124, a touch panel 126 disposed on top of the display screen 106, a location detection module 128, a memory 130 and a biosensor module 132. In various embodiments of the invention, one or more of the above-listed modules or functional units may be omitted from or moved relative to one another (e.g., completely removing touch panel 126 or moving touch panel 126 to another location other than on top of the display screen 106) the wearable computer system 100. In other words, the invention does not require each and every module or functional unit illustrated in FIG. 1 to be present in every embodiment of the invention. Further, the wearable computer could communicate with a paired second wearable computer or non-wearable computer to benefit from modules present in separate devices.

The control module 102 controls the overall functionality of the wearable computer 100. As would be understood by those of ordinary skill in the art the control module 102 may be implemented, or realized, in many different forms known in the art, such as, for example, with a general purpose processor (e.g., CPU) and addressable memory storing instructions thereon, a microprocessor, a digital signal processor, an application specific integrated circuit, a field programmable gate array, any suitable programmable logic device, discrete gate or transistor logic, discrete hardware components, or any combination thereof, which are designed to perform the functions described herein. The control module 102 may also be implemented as a combination of computing devices, e.g., a combination of a digital signal processor and a microprocessor, a plurality of microprocessors, one or more microprocessors in conjunction with a digital signal processor core, or any other configurations known in the art.

The communication module 104 includes radio frequency (RF) circuitry for transmitting and receiving RF signals via an integrated or separate external antenna 105 that is coupled to or part of the communication module 104. In one embodiment, communication module 104 includes short range (e.g., Bluetooth) RF communications circuitry configured to communicate with one or more external non-wearable computing devices (not shown) that are located within a certain range of the wearable computer 100. Such short range communication circuits are less expensive and/or require less device “real estate” than more powerful and complex long-range communication circuits (e.g., CDMA chip sets). Additionally, short range communication circuits require less power to operate than longer range communication circuits.

In a further embodiment, as the size of integrated circuits continues to decrease and the charge capacity of power sources continues to increase, it is contemplated that the communication module 104 may include both short and long range communication circuits or capability or exclusively long range communication circuitry. To address the increased power consumption required by long range communication circuits, in one embodiment, the wearable computer is configured to be primarily in short range communication mode as a default setting, and can be switched to a long range communication mode for emergency situations or when a non-wearable computer is not detected.

The communication module 104 can receive RF signals from a communicatively coupled non-wearable computer, which inform the wearable computer 100 of an event (e.g., an incoming phone call or a received text message or e-mail), as discussed in further detail below. The communication module 104 receives RF signals containing instructions, audio, text, image and/or video information from a non-wearable computer via antenna 105 and demodulates and decodes such signals into corresponding data that is then provided to the control module 102 for processing. Additionally, the communication module 104 can also transmit RF signals to one or more non-wearable computers to perform one or more control operations, as also discussed in further detail below.

The display screen 106 receives control signals from the control module 102 and displays text, images and/or video to a user. The display screen may be implemented utilizing various known technologies (e.g., liquid crystal display, light emitting diode, quantum dot, interferometric modulator, etc.). Text, image and/or video information is provided by the control module 102 to the display screen 106, or to a video decoder 108, as necessary, for subsequent display on the display screen 106. The video decoder 108 converts signals from the control module 102 into video signals that can be displayed on the display 106, and outputs the signals to the display 106.

Audio data is provided by the control module 102 to an audio decoder 110 which decodes the audio data to generate analog audio signals, which are then provided to a speaker 112 for listening by a user.

In one embodiment, the wearable computer 100 is provided with an internal vibrator 114 located within the housing of the wearable computer 100. The vibrator 114 is controlled or activated by the control module 102 and vibrates to provide an alert or notification of a predetermined event, as discussed in further detail below.

In a further embodiment, the wearable computer 100 may include a MEMS (microelectromechanical systems) gyroscope and/or accelerometer module 116, which can detect an orientation, velocity, and/or acceleration of the wearable computer 100 as a user moves. Based on such detected states, the wearable computer 100 can perform one or more predetermined functions, as discussed in further detail below.

The wearable computer 100 includes a built-in power supply 118 for supplying power to the control module 102 and other modules of the system 100 discussed herein. In one embodiment, the power supply 118 comprises a rechargeable lithium ion battery cell. However, any suitable rechargeable battery or power source can be utilized by the present invention.

In one embodiment, the wearable computer 100 includes one or more input or selection buttons 120 located on a surface of its housing. As discussed in further detail below, such buttons 120 can be pressed by a user to perform one or more predetermined functions, which are initiated by the control module 102 in response to detecting user activation of the buttons 120.

In one embodiment, a microphone 122 and audio encoder 124 are also provided. The microphone 122 receives analog audio signals from a user, for example, and converts such audio signals into electrical signals, which are then provided to the audio encoder 124. The audio encoder 124 converts the electrical audio signals from the microphone 122 into digital signals that are then provided to the control module 102 for processing. As described in further detail below, such audio signals can be converted into text or commands, utilizing voice recognition software, for example, and transmitted to one or more non-wearable computers.

To supplement or replace the functionality of the input/selection buttons 120, the wearable computer can also include a touch panel 126, which is disposed on top of the display screen 106 to work in conjunction with images, menu items, icons, etc. that may be displayed by the display screen 106. As discussed in further detail below, a user may perform one or more predetermined gestures on the touch panel 126 to perform corresponding predetermined functions. The touch panel 126 formed on top of the display screen 106 together provide a “touch screen display” as discussed below in conjunction with various embodiments of the invention.

In a further embodiment, the wearable computer 100 can also include a location detection module 128 for allowing the wearable computer 100 to determine its present location. As discussed in further detail below, one or more predetermined functions can be performed based on the determined location of the wearable computer 100. However, any suitable positioning module, including at least satellite and terrestrial positioning systems, can be used without departing from the present invention.

The wearable computer 100 also includes a memory 130, which can include both a ROM and a RAM. The memory 130 stores one or more computer executable control programs for controlling the various operations of the control module 102, as discussed herein. Moreover, the memory 130 stores application data for performing the various applications discussed herein, and can also store user data such as pre-recorded or saved voice messages, e-mails, texts, images, videos, etc. that is saved by a user or an application for later use.

In a further embodiment, the wearable computer 100 can include a biosensor module 132 (e.g., a temperature monitor, a pulse monitor, and/or moisture monitor), for example, to detect one or more bio-status conditions (e.g., sleep, exercise, hot, cold, etc.) of the user. As discussed in further detail below, in some embodiments, the wearable computer 100 performs or adjusts one or more predetermined functions based on a detected bio-status of the user.

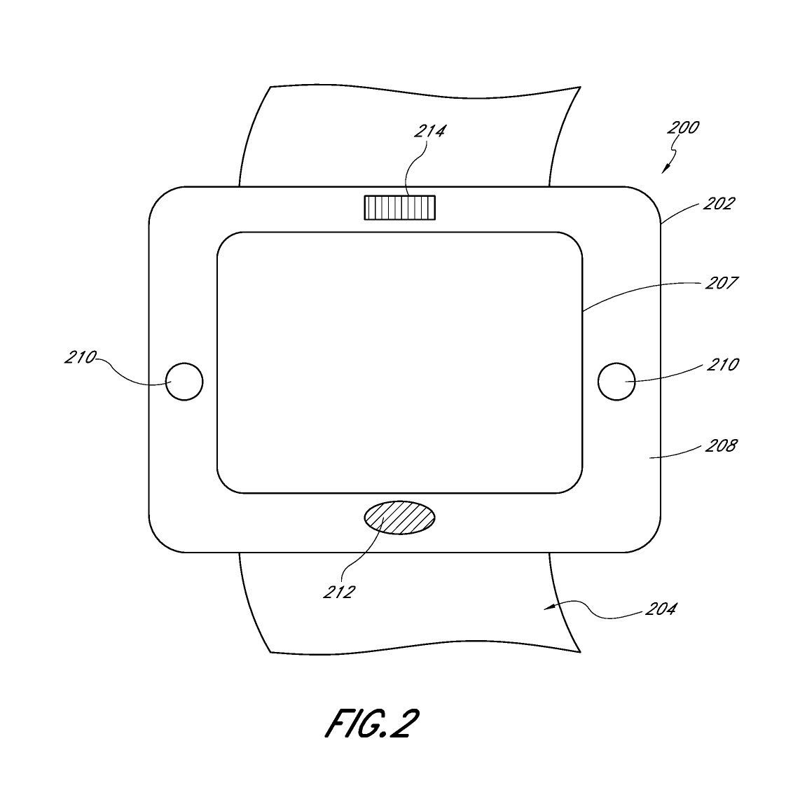

FIG. 2 illustrates an exemplary wearable computer 200 configured in the form of a wrist-watch device, in accordance with one embodiment of the invention. In this embodiment, the wearable computer 200 includes a main housing 202 coupled to a wrist band 204 made from any suitable material to allow a user to wear the wearable computer 200 in similar fashion to a conventional wrist watch.

The wearable computer 200 includes a touch screen display 207 located on a front face of the housing 202. The touch screen display 207 comprises a display screen and a touch panel overlaid on top of the display screen. The portions of the front surface of the housing 202 that surrounds the touch screen display 207 form a bezel 208. Located on the bezel 208 are one or more input/selection buttons 210 configured to be pressed by a user to activate or initiate one or more predetermined functions, as discussed in further detail below. Either the bezel 208 or the wrist band 204 can be swapped to adjust the ornamental appearance of the wearable computer 200.

In one embodiment, the wearable computer 200 includes a microphone 212 and a speaker 214. The microphone 212 receives audio input (e.g., analog voice signals or general background noise) to perform various functions. For example, voice commands may be translated into appropriate data signals to perform one or more predetermined functions (e.g., “Shut off phone ringer”). Alternatively, the wearable computer 200 can simply record and store voice memos or notes desired to be saved by a user. Further, the wearable computer 200 can monitor background volume to change device mode or adjust volume on the wearable computer 200 or on the paired non-wearable computer. The speaker 214 outputs audio signals (e.g., voice messages transmitted from a smart phone or rep number during workout) for the user to hear.

FIG. 3 illustrates a wearable computer 300 configured in the form of a necklace, in accordance with another embodiment of the invention. The wearable computer 300 includes a housing 302, which is coupled to a necklace chain 304 via a loop 305. A touch screen display 307 is located on a front surface of the housing 302 and defines a bezel 308 surrounding the touch screen display 307. One or more input/selection buttons 310, a microphone 312 and a speaker 314 are also located on the bezel 308. The loop 305 can be attached to swappable bezel 308. The functionality of the elements in FIG. 3 can be similar or identical to that of corresponding elements described with reference to FIG. 2. Therefore, a more detailed description of each element of FIG. 3 will not be repeated here. Additional wearable computer form factors may include the functionality of the present invention, but further form factors will not be illustrated.

Some exemplary functions of the wearable computer system of the present invention are described below.

When a wireless communication link is established between the wearable computer of the present invention and a non-wearable computer (e.g., a smart phone), the non-wearable computer can send notifications and information to the wearable computer concerning certain predetermined events. In the examples discussed below, it is contemplated that the non-wearable computer is a smart phone having wireless phone, e-mail, text message, and Internet browsing functionality, and which is communicatively coupled to the wearable computer 200 of FIG. 2 via a short range wireless communication protocol (e.g., Bluetooth). However, it will be understood by those of ordinary skill in the art that the non-wearable computer may be any type of computing device (e.g., a tablet computer, gaming console, smart television, laptop computer, personal digital assistant (PDA), or a desktop personal computer (PC)), for example.

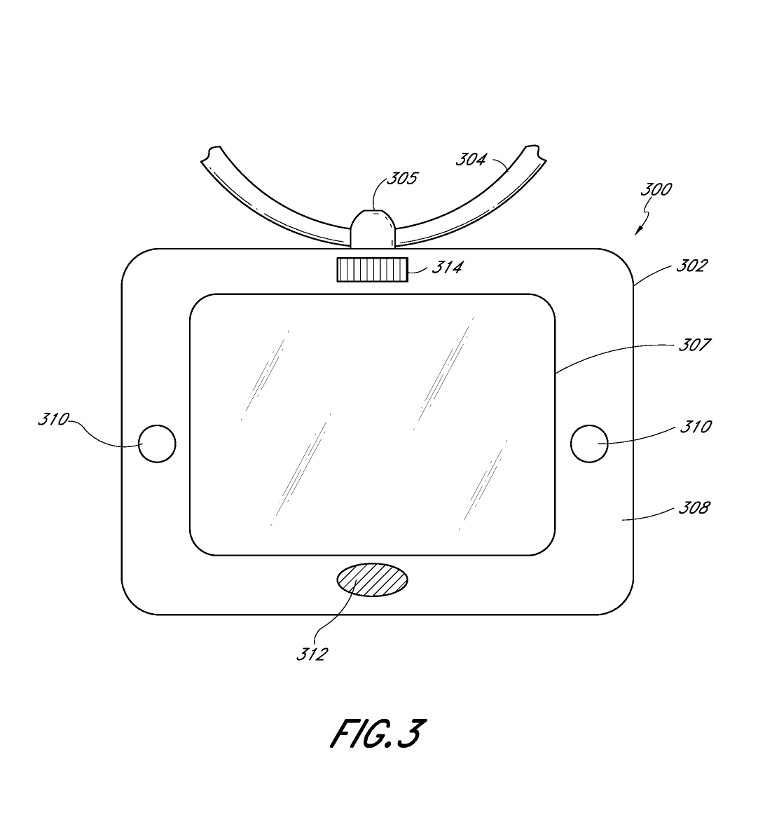

Referring to FIG. 4A, when the smart phone receives an incoming call, it sends a signal to the wearable computer 200, to notify the wearable computer 200 of the incoming call and any information associated with the call. In response to receiving the signal from the smart phone, an exemplary message of “You have an incoming call from Daniel. Answer call via wearable computer (WC)?” is displayed on the touch screen display 207 of wearable computer 200, in accordance with one embodiment of the invention. In this example, it is assumed that “Daniel” is a recognized contact that is stored in a memory of the smart phone. If the incoming call is not from a recognized contact, instead of displaying a name, a phone number or simply “unknown” may be displayed.

In response to the message displayed on the touch screen display 207, the user can perform a predetermined gesture such as sliding a finger to the right on the touch screen display 207 to answer the incoming call via the wearable computer 200, or sliding the finger to the left to decline answering the incoming call. If the user chooses to answer the call, the call is forwarded to the wearable computer 200 and the user can speak to the caller via microphone 212 and speaker 214, and the various functional modules and circuits discussed above with reference to FIG. 1 (e.g., communication module 104). It is appreciated that allowing a user to answer the phone call using the wearable computer, as discussed above, provides greater convenience to the user. For example, if the user is driving her car and her smart phone is not readily accessible, she can simply answer the phone via her wearable computer located on her wrist. Additionally, in this situation, answering the phone call and engaging in a discussion with the caller while driving is much safer since the user does not have to first locate and retrieve her smart phone and thereafter hold the smart phone in one hand to talk with the caller. Since the wearable computer 200 is located and secured to her wrist, the user can maintain both hands on the steering wheel while talking, which greatly increases safety for the user and other drivers on the road.

If the user declines to answer the incoming phone call by sliding her finger on the touch screen to the left, for example, in one embodiment, the user is presented with a second screen that provides a menu of functions that can be selected by the user, as illustrated in FIG. 4B. The menu items can include an “Ignore” function 402, a “Forward to Voice Mail” function 404, or an “Other” function 406 that may be programmed by the user or wearable computer manufacturer as desired. Such “Other” functions may include functions such as Forward to Voice Mail and send a predetermined text message such as “Sorry I can't answer your call now. I will respond as soon as I can.” In this exemplary scenario, the wearable computer 200 instructs the smart phone to send the incoming phone call to a pre-designated voice mail box, and further instructs the smart phone to transmit the predetermined text message to the phone number associated with the incoming call. “Other” function 406 can also lead to an option to initiate a text-to-speech and speech-to-text conversation, in which the user is presented with voice recognized text of the incoming call audio and a series of options that are either simple and pre-set or intelligently predicted based on the content and context of the incoming call audio. The user's selected responses can be transmitted as either text or audio to the incoming call. Many “other” functions may be programmed and customized by a user.

The input/selection buttons 210 may be programmed to have dedicated functions as desired by the user and/or manufacturer. In one embodiment, the wearable computer 200 may not include a touch panel but only a display screen that does not have touch input capabilities. In this embodiment the buttons 210 may be assigned as “Yes” or “No” buttons that would replace the sliding gestures performed on a touch screen display, as discussed above. In this embodiment, various functions can be implemented by displaying “Yes/No” type questions on the display screen and allowing the user to select the desired response using the buttons 210. Buttons 210 could also be used to flip through presented options on screen. It is contemplated that additional buttons 210 may be incorporated on the bezel 202 as desired to implement certain functions and/or design considerations.

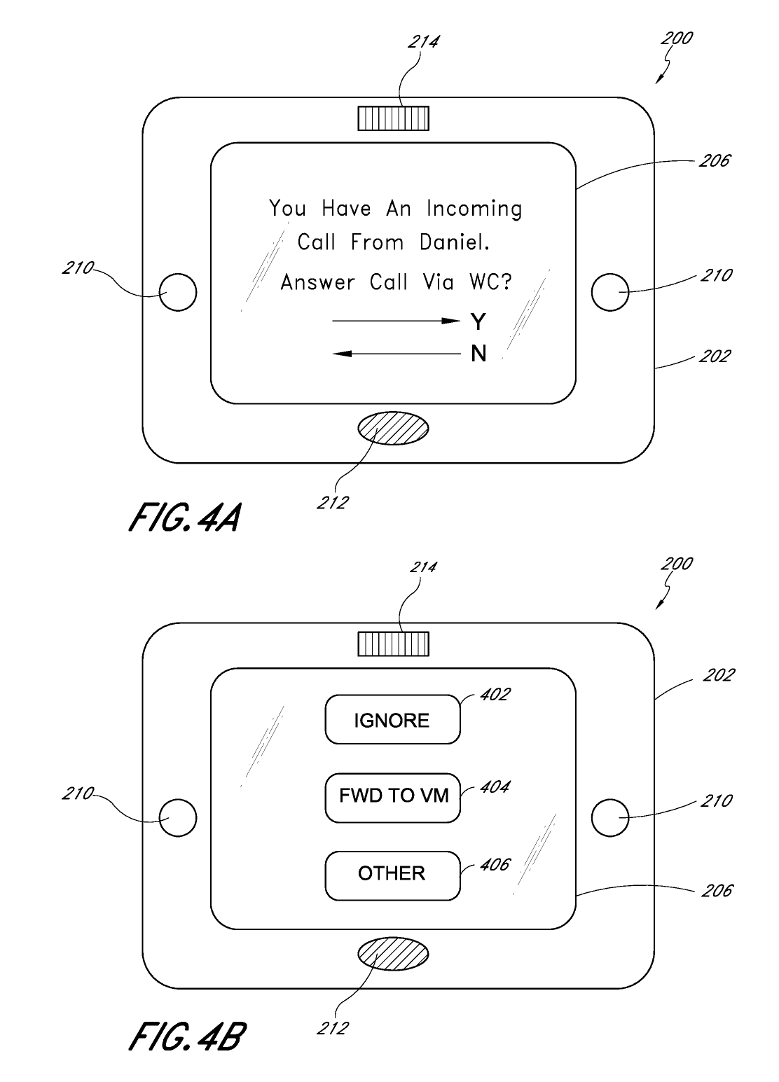

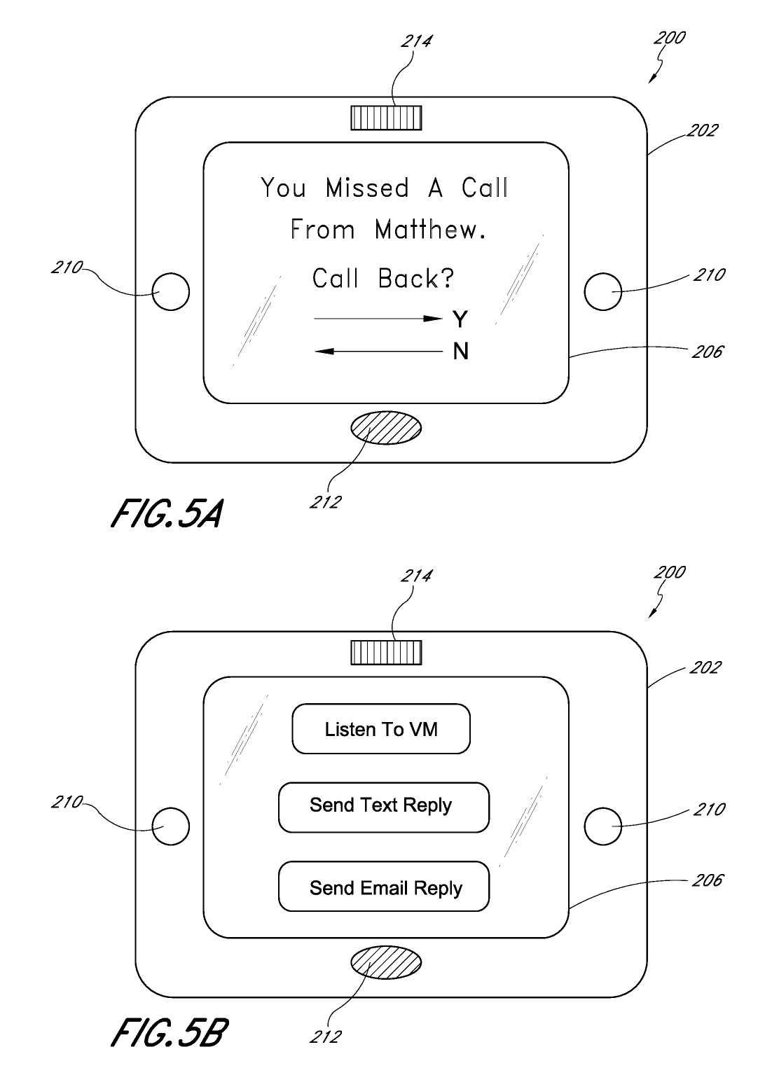

FIG. 5A illustrates another exemplary message that may be displayed on the touch screen display 207. In this example, the message “You missed a call from Matthew. Call back?” is displayed. Similar to the discussion above, the user may perform sliding gestures on the touch screen display 207, or press one of buttons 210 to either call back or not call Matthew back. If the user selects to call Matthew back, in one embodiment, the wearable computer 200 instructs the smart phone to call Matthew and thereafter function as the long-range transceiver for the wearable computer 200, wherein audio signals are relayed between the wearable computer 200 and the smart phone during the telephone call with Matthew. In an alternative embodiment, if the wearable computer 200 contains a communication module 200 that is equipped with long-range communication circuits capable of communicating with a base station, then the wearable computer 200 may directly call Matthew back without the assistance of the smart phone.

As shown in FIG. 5B, if the user declines to call Matthew back, in one embodiment, the touch screen display 207 displays a menu of additional options that may be selected by the user. Such menu options can include, for example, a “Listen to Voice Mail” icon 502, a “Send Text Reply” icon 504 or “Send Email Reply” icon 506. Upon selecting one of these options, the wearable computer 200 communicates and works in conjunction with the smart phone to initiate and perform the selected function.

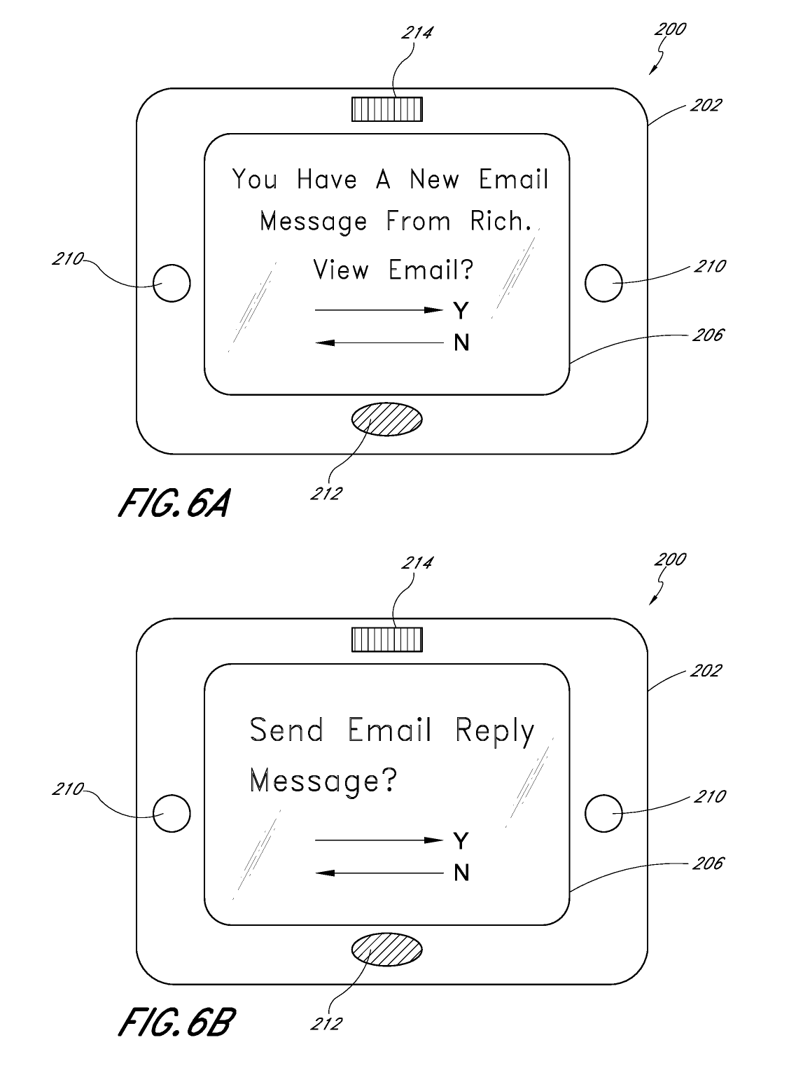

FIG. 6A illustrates another exemplary message that may be displayed on the touch screen display 207 of wearable computer 200. In this example, the message “You have a new email from Rich. View email?” is displayed. Similar to the discussion above, the user may perform sliding gestures on the touch screen display 207, or press one of buttons 210 to view or not view the email. If the user selects to view the email, in one embodiment, the wearable computer 200 instructs the smart phone to forward the email to the wearable computer 200. The email message is then displayed as text on the touch screen display 207 and the user may scroll through text by sliding her finger in an up or down direction on the touch screen display 207. In a further embodiment, appropriate software stored in a memory of the wearable computer 200 or the smart phone, and executed by the wearable computer 200 or smart phone, respectively, may summarize or condense the email text into a shorter form for easier display and viewing by the user on the touch screen display 207.

After the user reads the email, or summary thereof, by pressing one of the input/selection buttons 210, or performing a predetermined gesture on the touch screen display 207, the user can call up the display screen message shown in FIG. 6B, which asks “Send email reply message?” In response, as discussed above, the user may perform sliding gestures on the touch screen display 207, or press one of buttons 210 to send or not send the reply email. If the user selects to send a reply email to Rich, the wearable computer 200 instructs the smart phone to transmit a predetermined reply email message to Rich. In alternative embodiments, the user can dictate a voice message into the wearable computer microphone 212 or the smart phone microphone, which is then transcribed into text by voice recognition software residing in a memory of the wearable computer or the smart phone, and thereafter transmitted by the smart phone to Rich's email address. In an alternative embodiment, if the wearable computer 200 is equipped with Internet communications capability, the wearable computer 200 can transmit the transcribed voice message text directly to Rich's email address without further assistance from the smart phone.

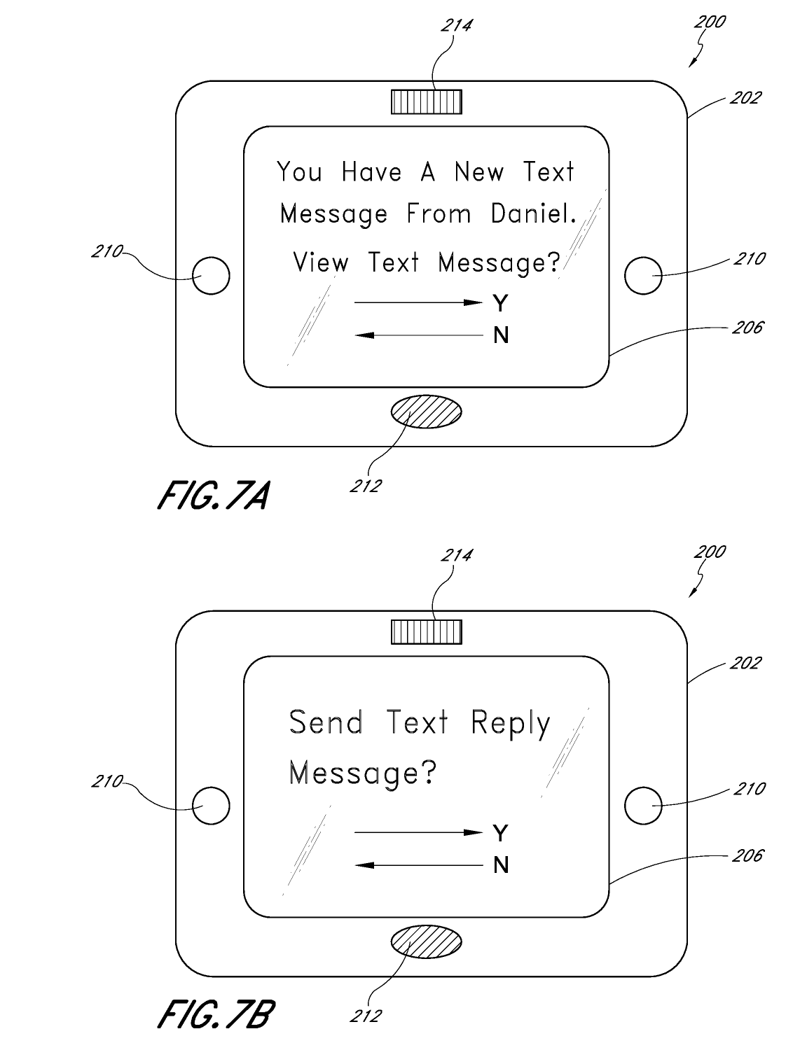

FIG. 7A illustrates another exemplary message that may displayed on the touch screen display 207. In this example, the message “You have a new text message from Daniel. View text message?” is displayed. Similar to the discussion above, the user may perform sliding gestures on the touch screen display 207, or press one of buttons 210 to either view or not view the text message. If the user selects to view the text message, in one embodiment, the wearable computer 200 instructs the smart phone to forward the text message to the wearable computer 200. The text message is then displayed as text on the touch screen display 207 and the user may scroll through text by sliding her finger in an up or down direction on the touch screen display 207. In a further embodiment, appropriate software stored in a memory of the wearable computer 200 or the smart phone, and executed by the wearable computer 200 or smart phone, respectively, may summarize or condense the text message into a shorter form for easier display and viewing by the user on the touch screen display 207.

After the user reads the text message, or summary thereof, by pressing one of the input/selection buttons 210, or performing a predetermined gesture on the touch screen display 207, the user can call up the display screen message shown in FIG. 7B, which asks “Send text reply message?” In response, as discussed above, the user may perform sliding gestures on the touch screen display 207, or press one of buttons 210 to send or not send the text reply message. If the user selects to send a text reply message to Daniel's device, the wearable computer 200 instructs the smart phone to transmit a predetermined text reply email message to Daniel. In alternative embodiments, the user can dictate a voice message into the wearable computer microphone 212, which is then transcribed into text by voice recognition software residing in a memory of the wearable computer or the smart phone, and executed by the wearable computer 200 or smart phone, respectively, and thereafter transmitted by the smart phone to Daniel's device that transmitted the original text message. In an alternative embodiment, if the wearable computer 200 is equipped with text messaging capability, the wearable computer 200 can transmit the transcribed voice message text directly to Daniel's device without further assistance from the smart phone.

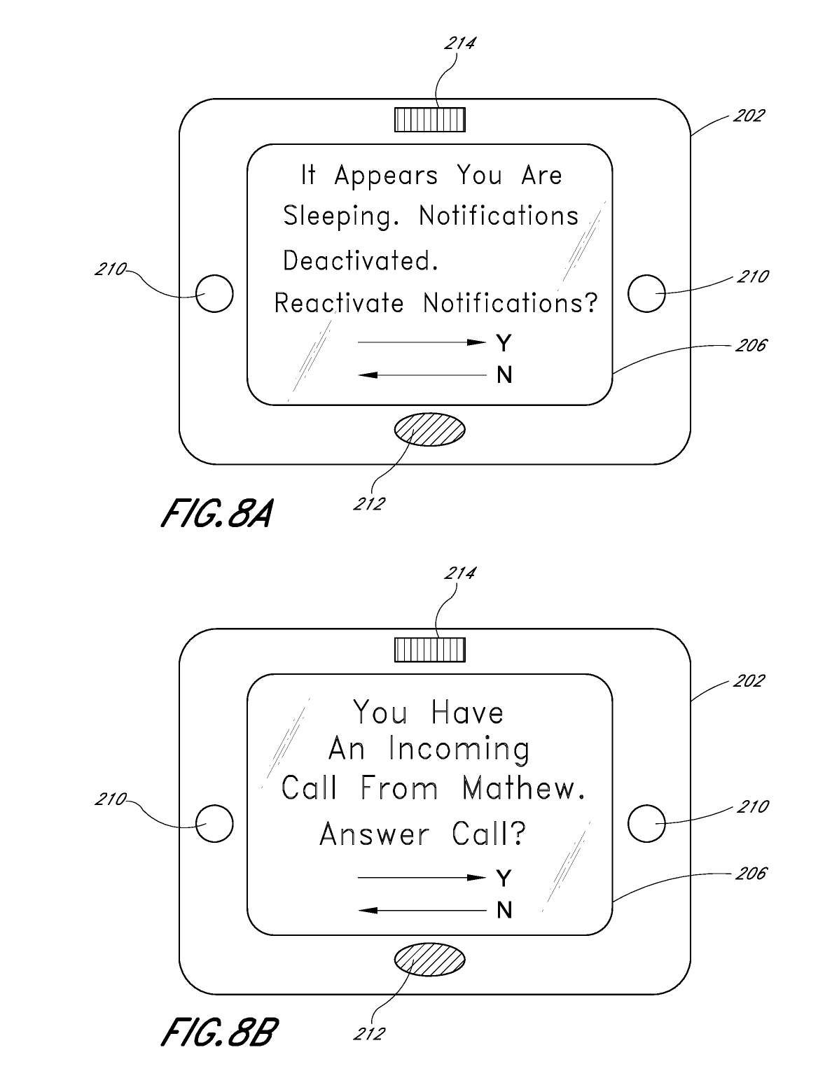

FIG. 8A illustrates another exemplary message that may be displayed on the touch screen display 207. In this example, the message states “It appears you are sleeping. Notifications deactivated. Reactivate Notifications?” In one embodiment, this message is displayed when a biosensor module 132 incorporated into the wearable computer 200 senses that the user is sleeping. Biosensors capable of detecting a user's activity level are known in the art For example, the biosensors could detect sleep by detecting a change in skin temperature, a change in heart-rate, a change in brain-activity, or a sustained decrease in detected motion. In response to the biosensor module 132 detecting that the user is likely sleeping, any notifications received from the smart phone are ignored. In one embodiment, such notifications can be temporally stored for later display at the user's option.

When the user wakes up, or if the biosensor incorrectly determined a sleep state of the user, the user can reactivate notifications by performing an appropriate gesture on the touch screen display 207 or pushing one of the selection buttons 210. In a further embodiment, even if the user is correctly determined to be in a sleep state, priority notifications from pre-designated individuals such as a teenage child or an important business colleague, for example, can override the deactivated notification status and still be received by the wearable computer 200. In this embodiment, the user selects and stores the contact information for such individuals that would trigger a priority notification event.

As shown in FIG. 8B, an exemplary priority notification can be displayed as “You have an incoming call from Matthew. Answer call?” In addition to this displayed message, in one embodiment, a predetermined audible alarm is sounded by the speaker 214. In response to this notification, the user can choose to either answer or not answer the call, or if she has missed the call, to call Matthew back, in similar fashion to the processes discussed above.

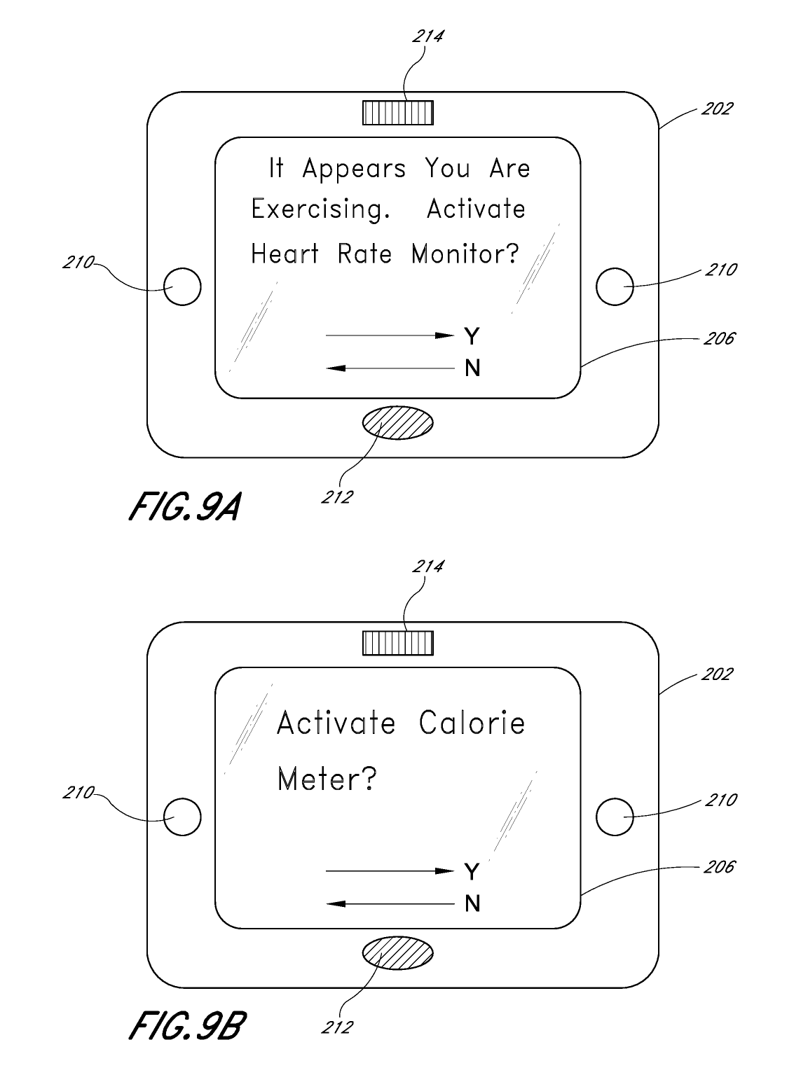

FIG. 9A illustrates another exemplary message that can be displayed on the touch screen display 207. In this example, the message displayed is “It appears you are exercising. Activate heart rate monitor?” In one embodiment, the biosensor module 132 can detect if the user is in a state of physical exertion or exercise. This physical exertion or exercise detection may be augmented or performed based on information received from Gyroscope/accelerometer 116. Such sensors and detection algorithms are well known in the art. In response to detecting that the user is exercising, the wearable computer 200 can perform one or more predetermined functions based on this determination. As one example, the display inquires whether the user wishes to activate the biosensor module 132 as a heart rate monitor, as shown in FIG. 9A. By performing an appropriate gesture on the touch screen display 207 or pressing one of the input/selection buttons 210, the user can choose to activate or not activate the heart rate monitor function of the biosensor module 132.

As another example, upon detecting that the user is exercising, the touch screen display 207 can display the message “Activate Calorie Meter?” The user can choose to activate or not activate a calorie meter function based on data collected by the biosensor module 132 and/or the gyroscope/accelerometer 116 by performing appropriate input functions using the touch screen display 207 or buttons 210 as discussed above. If the user selects to activate the calorie meter function, the biosensor module 132 measures the amount of calories burned by the user during her exercise session. The wearable computer 200 could transmit data to the smart phone to play an audible message such as “You have burned 300 calories”. A similar function could be performed to process data from the biosensor module 132 to verify that user heart rate remains within the fat burning zone or the aerobic zone. If user heart rate is measured to drop below or climb above the selected zone, wearable computer 200 can transmit an instruction to the smart phone to play a message such as “Slow down to remain in the fat burning zone”.

As contemplated to be within the scope of the present invention, various custom functions can be set or programmed to automatically activate based on various detected status conditions of the user or the user's surroundings. For example, if it is determined that the user is exercising, in one embodiment, notifications may be automatically deactivated only to be over-ridden by pre-designated priority notifications, as discussed above. In another embodiment, a user may manually select to deactivate notifications if the user does not wish to be interrupted or distracted during a certain period of time. In this scenario, the user can also program priority notifications to override such a manual deactivation status. As a further example, if a user is detected to be exercising, the wearable computer may automatically adjust certain settings such as increasing volume of audible alerts so the user can more readily hear them, for example.

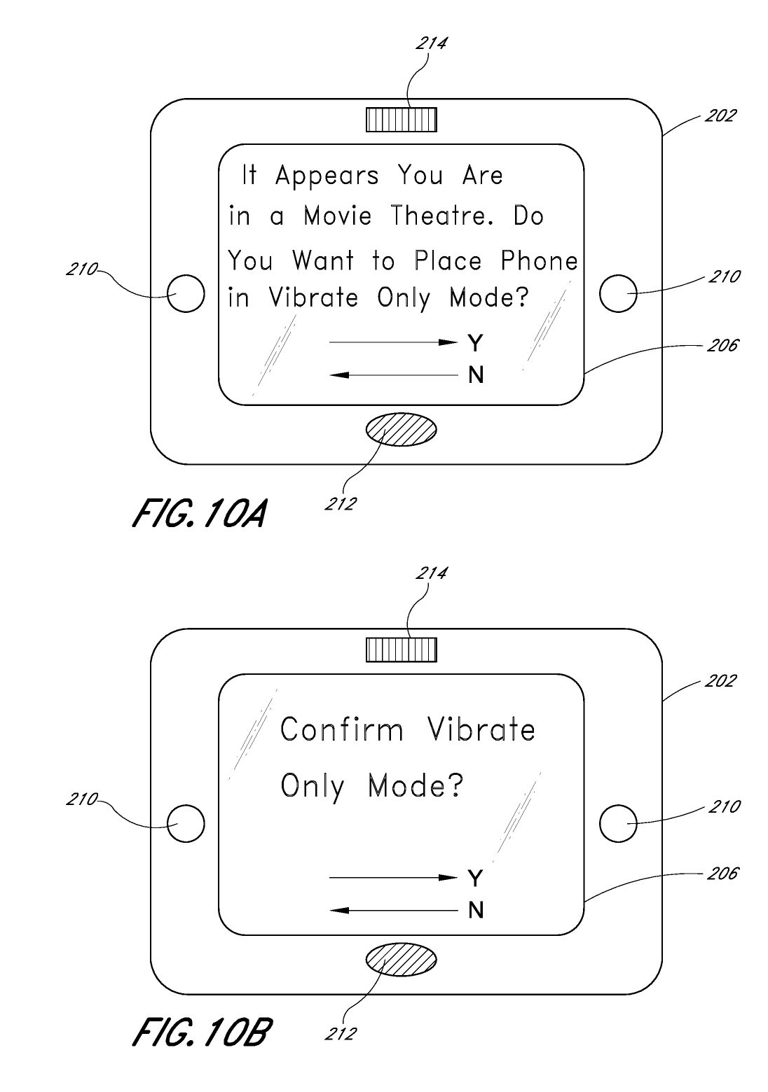

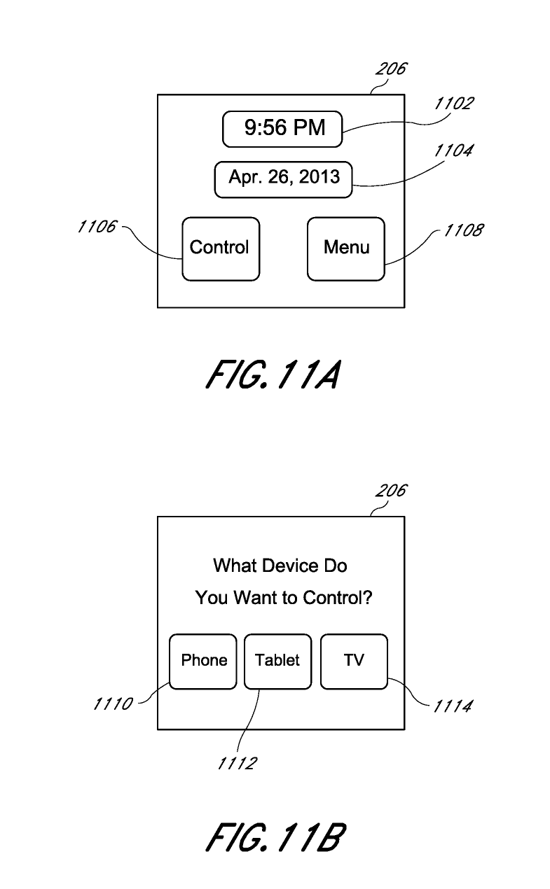

FIG. 10A illustrates another exemplary message that may be displayed on touch screen display 207. In this example, the message states “It appears you are in a movie theater. Do you want to place phone in vibrate only mode?” In one embodiment, the wearable computer 200 is equipped with a location detection module 128 that can determine the location of the wearable computer 200 using well-known GPS technologies. Upon determining that the user is located at certain pre-determined locations, the wearable computer can automatically perform certain functions.

In the example shown in FIG. 10A, the location detection module 128 has determined that the user is in a location corresponding to a movie theater. Mapping various types of locations (e.g., movie theater, shopping mall, work location) into the wearable computer 20 can be performed using technologies similar to those used to map various golf course details into a GPS range finder, for example. Upon determining that the user is in a movie theater, the wearable computer 200 inquires whether the user wishes to place her phone in vibrate only mode, so the user and other patrons are not disturbed by the sound of a ringing phone during the movie. The user can select “yes” or “no” using the touch screen display 207 or buttons 210, as described above. In an alternative embodiment, the wearable computer 200 may not ask the user to choose but instead automatically send a control signal to the smart phone to automatically place the smart phone in vibrate only mode and to dim the screen on both the wearable computer and the coupled smart phone. Additionally some incidental light functions such as an illumination mode on a wrist-worn wearable computer could be suppressed to minimize accidental illumination and distraction.

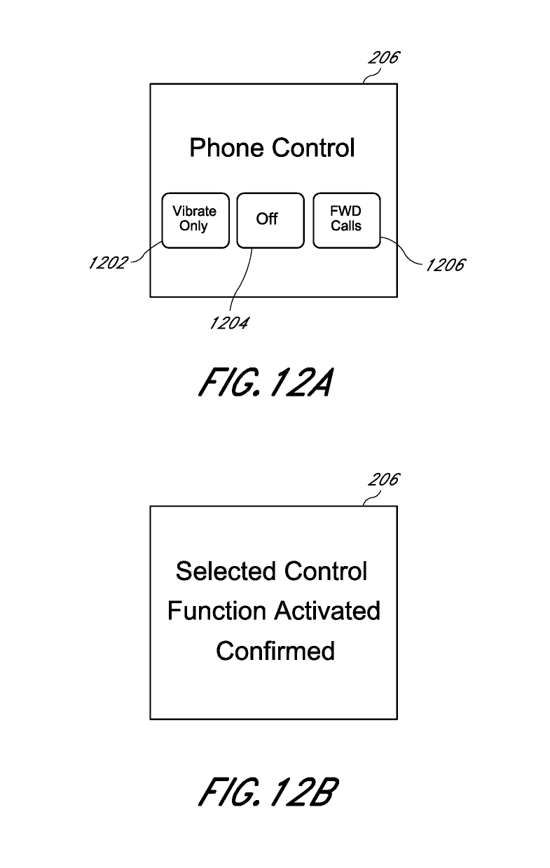

In a further embodiment, the wearable computer 200 can be used to manually control one or more external computing devices. Referring to FIG. 11A, in one embodiment, the wearable computer touch screen display 207 functions as conventional digital watch and displays time 1102 and date 1104. Additionally, the touch screen display 207 displays one or more touch screen menu icons such as a “control” icon 1106 and a “menu” icon 1108. The control icon 1106 may be selected by a user to control one or more predetermined non-wearable computers. The menu icon 1108 may be selected to access one or more predetermined menu functions or applications (e.g., activate heart rate monitor, reminders, task list, notepad function, games, etc.) that can programmed into or stored in the memory of the wearable computer. It is appreciated that any suitable application or program can be stored in the memory of the wearable computer 200, limited only by the amount of memory space available and the user interface required to execute or perform such applications.

If the user selects the “control” icon 1106, a subsequent display screen is shown as illustrated in FIG. 11B. In this display screen, a user interface screen that includes the message “What device do you want to control?” is displayed along with three exemplary selectable icons: phone icon 1110, tablet icon 1112 and TV icon 1114.

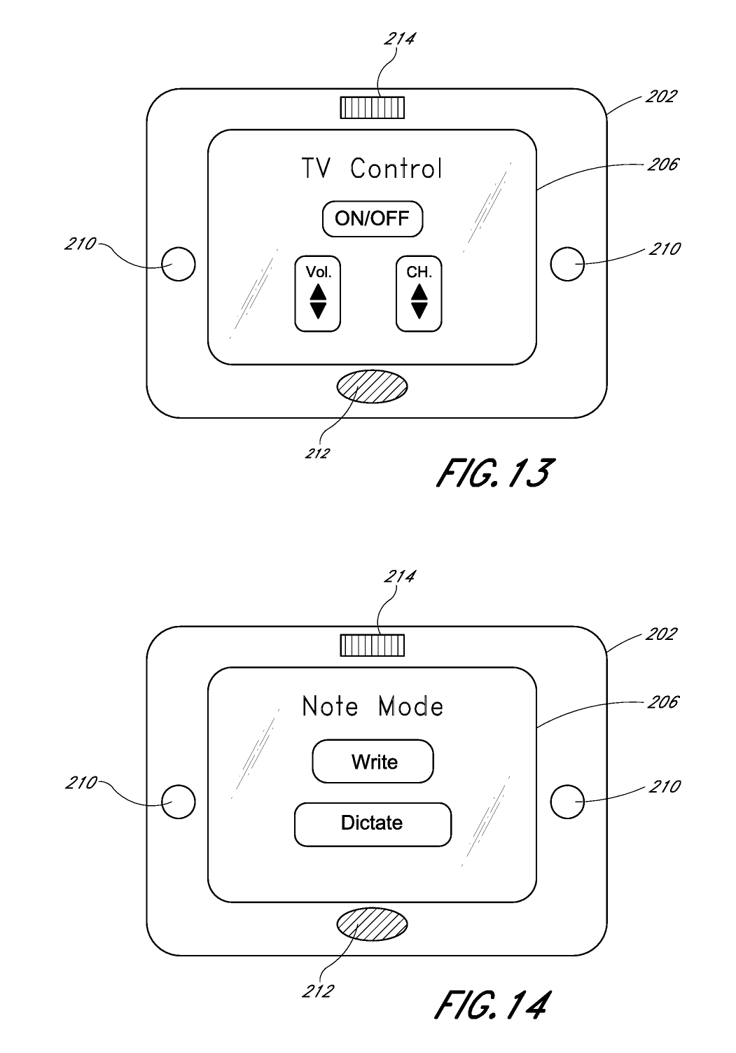

If the phone icon 1110 is selected, a new user interface screen is displayed as shown in FIG. 12A. In this user interface screen, the title “Phone Control” is displayed along with three exemplary selectable control icons: “Vibrate only” icon 1202, “Off” icon 1204 and “Fwd Calls” icon 1207. Upon detecting a selection of one of these control icons, the control module 102 will transmit an appropriate control signal to the smart phone to place it in a corresponding state. In this way, the wearable computer 200 can remotely control the smart phone even when the smart phone is not easily accessible by the user in a quick and/or non-disruptive manner, thereby adding enhanced functionality, control and convenience to the user.

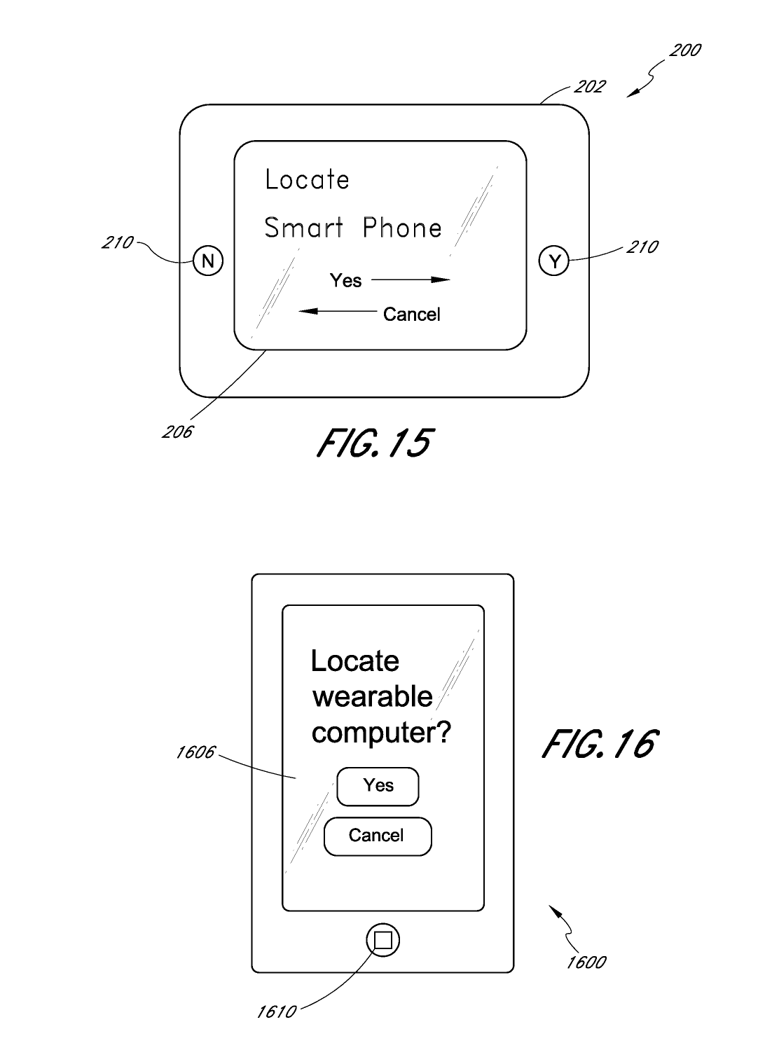

FIG. 13 illustrates an exemplary user interface screen displayed on the display 207 when the user selects the “TV” control icon 1114 (FIG. 11B). The user interface screen includes the title “TV Control” and three input functions: “ON/Off” icon 1302, “Volume up/down” icon 1304 and “Channel up/down” icon 1306. By selecting each item the user can control corresponding functions of a communicatively coupled device also equipped with a control module and communication module of its own (e.g., a smart television, a gaming console attached to a television, or a cable/satellite receiver console attached to a television), thereby converting the wearable computer 200 into a convenient television remote controller.

It will be appreciated by those of ordinary skill in the art that the various non-wearable computing devices discussed herein will be programmed with appropriate application software to enable such computing devices to communicate with and operate in conjunction with the wearable computer of the present invention, in accordance with the exemplary functions described herein.

FIG. 14 illustrates an exemplary function of the wearable computer 200 as a standalone device. In this embodiment, the wearable computer 200 is in a “Note Mode” and the user may choose to write a note on the touch screen 207 using her finger or a stylus (not shown) by selecting a “Write” icon 1402, or dictate a note or voice message by choosing a “Dictate” icon 1404. Writings can be stored in memory as text or graphical images while dictations can be stored as audio files.

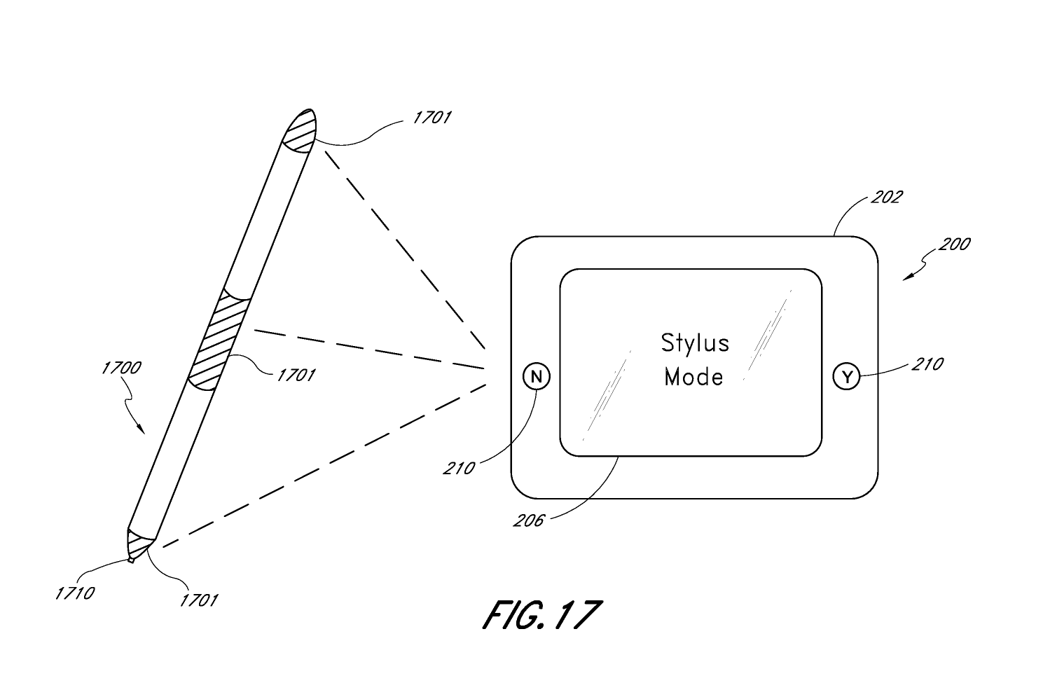

FIG. 15 illustrates an exemplary function through which wearable computer 200 can locate a coupled smart phone or send a signal to smart phone to activate a location assistance mode. In this embodiment, the wearable computer presents a user with the prompt “Locate Smart phone?” The user can confirm through commands sent either through the touch screen display 206 or the buttons 210. The location assistance mode signal can over-ride current smart phone 200 profile information such as volume or display dimming Location assistance mode could turn display brightness to maximum, play an attention-grabbing video or animated sequence, activate the smart phone camera flash, play an audio alert, and/or activate an internal smart phone vibrator. Location assistance mode could repeat continuously, pulse on and off at determined increments, or activate for only a short duration.

A wearable computer could also determine location of a user's keys, by pairing with a short-range wireless communication module (e.g., Bluetooth LE or RFID). This short-range wireless communication module could be specifically incorporated in a key-ring or key base to enable pairing, or the module could be incorporated directly into a pre-existing car remote. The wearable computer (or smartphone) could detect and recall where the wearable computer (or smartphone) was when it last communicated with the key communication module. It is a reasonable assumption that a key-ring usually remains where a user last left it, so by detecting where the communication ceased, a wearable computer or smartphone could suggest an informed location where a user should begin his or her key-ring search.

FIG. 16 illustrates an exemplary function through which smart phone 1600 can locate wearable computer 200, either by detecting and displaying location and directions on smartphone display 1606 or by sending a signal to wearable computer 200 to activate location assistance mode. In this embodiment, the smartphone presents a user with the prompt “Locate wearable computer?”, and the user can confirm through commands sent either through the smartphone display 1606 or the buttons 1610. The signal can over-ride current smart phone 200 profile information such as volume or display dimming A signal to locate a smart phone could turn display brightness to maximum, play an attention-grabbing video or animated sequence, activate a wearable computer flash or LED sequence, play an audio alert, and/or activate an internal smart phone vibrator. Location assistance mode could repeat continuously, pulse on and off at determined increments, or activate for only a short duration.

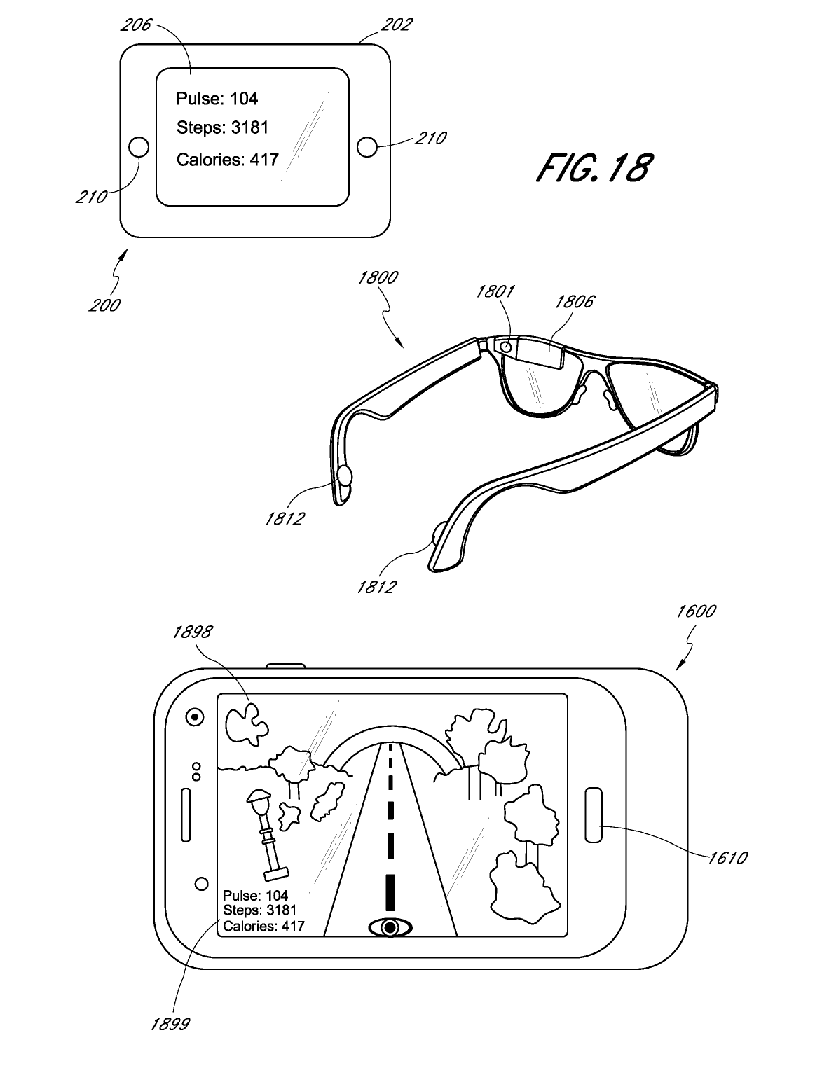

FIG. 17 illustrates a further embodiment, in which a wearable computer 200 could intelligently record writing from a peripheral stylus or pen 1700. By detecting the location and relative orientation of multiple point indicators 1701, wearable computer 200 can detect and record the location and movement of stylus or pen 1700. Multiple stylus indicators could be electronic indicators that broadcast a signal or manufactured from a material that reflects specific wavelengths. Wearable computer 200 can detect the location of each point indicator 1701 and extrapolate stylus position and movement to record the movement of pen or stylus tip 1710. By recording stylus tip movement, wearable computer can record hand-written notes. Stylus tip movement can be combined with precise wearable computer location and movement as determined by location detection module 128 and/or gyroscope/accelerometer 116 to determine exactly what marks a user made on a page. Additionally pen or stylus 1700 can transmit when pen or stylus tip 1710 is depressed to more accurately record what is actually recorded to a page. This process could be captured by wearable computer 200 and transmitted to a smart phone 1600 where the information is recorded in text form or exactly as drawn. Alternatively, the entire process could be captured by smart phone 1600, though this would lack the actual wrist location and movement data that a wearable computer 200 mounted on a wrist could capture. In an alternative embodiment, a stylus could be used as a wand or indicator. This concept would work equally well for a telescopic indicator or a laser pointer.

FIG. 18 shows multiple mobile devices working in unison to benefit from the different sensor packages on each device. In the present example, an eyeglass wearable computer 1800 is working with a wrist-mounted wearable computer 200 and a smartphone 1600. The eyeglass wearable computer 1800 includes a camera 1801, a display 1802, and may also include a eyeglass microphone (not shown), eyeglass headphones 1812, and an eyeglass wireless communications module (not shown). The wrist-mounted wearable computer 200 includes a main housing 202, a display 206, one or more input/selection buttons 210, as well as internal components such as a gyroscope/accelerometer module 116 (not shown), biosensor module 132 (not shown), and communication module 104 (not shown).

For example, a camera 1801 included in an eyeglass mounted wearable computer 1800 could be combined with a location detection module 1628 (not shown) in a smart phone and a biosensor in a wrist-mounted wearable computer to create one composite data stream. One example of combining the three above-mentioned devices would be that a user could record a video of his run along with an overhead track or lap view 1898 and an embedded data display 1899 including speed, number of steps, and bio data. The embedded data from embedded data display 1899 could be available both visually as part of a video and as a separate data stream that can be used within other applications. Additionally track or lap view 1898 and/or embedded data display 1899 can be minimized or hidden.

Additionally redundant sensors could work together to improve observed estimates. A user wearing eyeglass wearable computer 1800, a wrist-mounted wearable computer 200, and carrying a smartphone might have 3 different accelerometers or 3 different location detection modules. The system could use this redundant data to improve overall estimates or calculations. If two of three sensors sense that you took 25 steps instead of 35 steps, the system could create a phantom step variable that is the average of the three numbers, that omits the outlier, or the root mean square of the inputs. This phantom variable could also be calculated based on any other combination of sensor input. This same redundant data calculation could be performed for other such monitored variables as position, velocity, steps, pulse, or any other sampled number measured by multiple discreet sensors.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to hardware, firmware, software and appropriate processing circuitry for executing the software, and any combination of these elements for performing the associated functions described herein. Additionally, for purpose of discussion, the various modules are described herein as discrete modules; however, as would be apparent to one of ordinary skill in the art, two or more modules may be combined within a single integrated module that performs the associated functions according to various embodiments of the invention. Additionally, the functionality of one module may be distributed into two or more modules. Hence, references to specific functional modules or units are only to be seen as references to exemplary means for providing the described functionality, rather than indicative of a strict logical or physical structure or organization.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

One or more of the features illustrated in the drawings and/or described herein may be rearranged and/or combined into a single component or embodied in several components. Additional components may also be added. While certain example embodiments have been described and shown in the accompanying drawings, it is to be understood that such embodiments are merely illustrative of and not restrictive. Thus, the inventions are not limited to the specific constructions and arrangements shown and described, since various other modifications may occur to those ordinarily skilled in the art based on the present disclosure.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims. Method step and/or actions disclosed herein can be performed in conjunction with each other, and steps and/or actions can be further divided into additional steps and/or actions.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA), or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine, etc. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM, or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

It is to be understood that the claims are not limited to the precise configuration and components illustrated above. Various modifications, changes and variations may be made in the arrangement, operation and details of the methods and apparatus described above.

The following is claimed:

1. A wearable computer, comprising:
a control module;
an output element, coupled to the control module, and configured to convey a status alert to a user of the wearable computer; and
a wireless communication module, coupled to the control module, and configured to communicate with a separate computing device;
wherein the control module is configured to control the output element to convey a status alert to a user in response to a signal received by the wireless communication module from the separate computing device, wherein the signal indicates a status condition of the separate computer and the status alert informs a user of the wearable computer of the status condition.

2. The wearable computer of claim 1, wherein the output element includes a display screen and conveying a status alert is displaying a text and/or an image in response to the received signal.

3. The wearable computer of claim 1, wherein the separate computing device is a non-wearable computer.

4. The wearable computer of claim 1, wherein the separate computing device is a second wearable computer.

5. The wearable computer of claim 1, wherein the output element includes a vibration module and conveying a status alert is vibrating in response to the received signal.

6. The wearable computer of claim 1, wherein the output element includes a speaker, coupled to the control module, and conveying a status alert is providing an audible alert in response to the received signal.

7. The wearable computer of claim 1, wherein the status condition comprises a condition wherein the separate computing device is receiving an incoming phone call and the status alert notifies the user of the incoming phone call.

8. The wearable computer of claim 7, wherein the output element comprises a display screen, and wherein the control module is further configured to control the display screen to display at least one action that may be selected by the user in response to the incoming phone call.

9. The wearable computer of claim 8, wherein the at least one action comprises at least one action selected from a group consisting of: answer the incoming call; ignore the incoming call; send the incoming call to voice mail; send a text message to a device associated with the incoming call; and send an e-mail to the device associated with the incoming call.

10. The wearable computer of claim 9, further comprising a speaker and a microphone, and wherein if the at least one action selected by the user is to answer the incoming call, the control module is further configured to control the communication module to communicate with the separate computing device to allow the user to engage in a phone conversation using the speaker and microphone of the wearable computer.

11. The wearable computer of claim 1, wherein the status condition comprises a condition wherein the separate computing device has received a text message and the status alert notifies the user of the received text message.

12. The wearable computer of claim 11, wherein the output element comprises a display screen, and wherein the control module is further configured to control the display screen to display at least one action that may be selected by the user in response to the received text message.

13. The wearable computer of claim 12, wherein the at least one action comprises at least one action selected from a group consisting of: read the received text message; send a reply text message to a device associated with the received text message; initiate a telephone call to the device associated with the received text message; and send an e-mail to the device associated with the received text message.

14. The wearable computer of claim 13, wherein the control module is further configured to send a control signal to the separate computing device so that the separate computing device initiates the at least one action selected by the user.

15. The wearable computer of claim 1, wherein the status condition comprises a condition wherein the separate computing device has received an e-mail message and the status alert notifies the user of the received e-mail message.

16. The wearable computer of claim 15, wherein the output element comprises a display screen, and wherein the control module is further configured to control the display screen to display at least one action that may be selected by the user in response to the received e-mail message.

17. The wearable computer of claim 16, wherein the at least one action comprises at least one action selected from a group consisting of: read the received e-mail message; send a reply e-mail message to a device associated with the received e-mail message; initiate a telephone call to the device associated with the received e-mail message; and send a text message to the device associated with the received e-mail message.

18. The wearable computer of claim 17, wherein the control module is further configured to send a control signal to the separate computing device so that the separate computing device initiates the at least one action selected by the user.

19. The wearable computer of claim 1, further comprising a touch panel formed on top of a display screen, thereby providing a touch screen display, wherein the touch screen display is configured to receive at least one predetermined touch input from the user to initiate a selected action in response to the received signal.

20. The wearable computer of claim 1, further comprising at least one input button that when pressed by the user initiates a selected action in response to the received signal.
